(19) United States
(12) Patent Application Publication
(10) Pub. No.: US 2026/0064666 A1
(43) Pub. Date: Mar. 5, 2026

(54) HIGH-VOLUME OPERATIONS ON DOCUMENT STORE

(71) Applicant: SAP SE, Walldorf (DE)

(72) Inventor: Rohit DWIVEDI, Bangalore (IN)

(21) Appl. No.: 18/825,177

(22) Filed: Sep. 5, 2024

(51) Int. Cl. G06F 16/23; G06F 9/48; G06F 16/93

(52) U.S. Cl. CPC G06F 16/2386; G06F 9/4881; G06F 16/93

(57) ABSTRACT

Systems and methods include a first service to receive events from a first event log, a second service to receive events from a second event log, and a third service to receive events from both event logs. The first event log receives low event volumes and the second event log receives high event volumes. The first service and the second service update a document database based on events associated with non-priority data objects and the third service updates the document database based on events associated with priority data objects. More computing resources are employed to execute the third service than to execute the first service or the second service.

### BACKGROUND

Today's organizations collect and store large sets of data at an ever-increasing rate. This data may be stored and managed by disparate data sources, including but not limited to relational databases, non-relational databases, data warehouses, object stores, and data lakes. The volume of updates and accesses to the stored data can create processing bottlenecks.

The use of document databases can exacerbate these processing bottlenecks. It is often desirable to replicate data of a relational database to a document database to leverage fast fuzzy searching which may be provided by a document database. A document database is a type of NoSQL database in which data is stored in documents in a format similar to JavaScript Object Notation. Different documents may include different sets of fields, and different documents may share some or all of the same fields.

Updating data within a document database may consume significantly more time and resources than updating the same data in a relational database. For example, an address of a customer may be updated in a relational database by identifying a row of a Customer table which is associated with the customer and updating a value of an address field of the row. To replicate this address update in a document database, each document of the document database which includes the address must be located and updated. This multiplicative effort may result in long queues of data updates which have already been applied to a relational database and are waiting to be applied to the document database. A search of the document database will not reflect data updated in a relational database until a corresponding data update has reached the head of its queue and been applied to the document database.

Bulk data uploads can result in very long queues of data updates for a document database. For example, data updates resulting from user interface (UI) interactions may be of relatively low volume and replicated from a relational database to a document database in near real-time. Bulk data uploads such as nightly uploads from legacy on-premise systems may include a high volume of data updates and may therefore require long processing times for replication into a document database. The high volume of data updates from bulk data uploads may inhibit the application of data updates resulting from UI interactions. In the case of a multi-tenant application, a bulk data upload from one tenant may slow the application of data updates resulting from UI interactions of another tenant.

Systems are desired to facilitate efficient updating of document databases in response to high volumes of incoming data updates.

### BRIEF DESCRIPTION OF THE DRAWINGS

FIG. 1 is a block diagram of an architecture to update a document database according to some embodiments.

FIG. 2 illustrates documents within a document database according to some embodiments.

FIG. 3 comprises a flow diagram of a process to transmit incoming events to an event streaming platform according to some embodiments.

FIG. 4 is a user interface for viewing data of object instances according to some embodiments.

FIG. 5a, FIG. 5b and FIG. 5c comprise flow diagrams of processes to update a document database according to some embodiments.

FIG. 6 is a diagram of a service deployed within nodes of a container orchestration platform according to some embodiments.

FIG. 7 illustrates clusters of services for updating a document database according to some embodiments.

FIG. 8 illustrates a cloud-based architecture according to some embodiments.

### DETAILED DESCRIPTION

The following description is provided to enable any person in the art to make and use the described embodiments and sets forth the best mode contemplated for carrying out some embodiments. Various modifications, however, will be readily-apparent to those in the art.

Embodiments address the foregoing by separating the processing of updates to data objects based on both the source of the update and an object type of the updated object data object. Updates from a first type of data source are sent as events to a first event log and updates from a second type of data source are sent as events to a second event log. The first type of data source (e.g., client UI interactions) may provide regular low-volume updates and the second type of data source (e.g., backend bulk upload processes) may provide less-frequent but high-volume updates.

A first service receives events from the first event log, a second service receives events from the second event log, and a third service receives events from both event logs. The first service and the second service update a document database based on events associated with data objects of non-priority object types and the third service updates the document database based on events associated with data objects of non-priority object types.

Priority object types may include object types which are updated more often than non-priority object types and/or whose updates are desired to be reflected in the document database more quickly than updates to non-priority object types. The number of priority object types (e.g., 5) may be less than the number (e.g., 15) of non-priority object types. The third service may be allocated more computing resources (e.g., a greater number of pods) than the first service or the second service. Consequently, updates to data objects of the priority object types may be more quickly integrated into the document database than updates to data objects of non-priority object types.

According to some embodiments, response time is defined as a time between the saving of an update to an object instance in a relational database to a time at which the update is viewable in a document database. One way to improve response times would be to increase the computing resources available to the document database. However, such increases are expensive and undesirable. Embodiments advantageously allow a system to provide different response times for different update scenarios for a given document database.

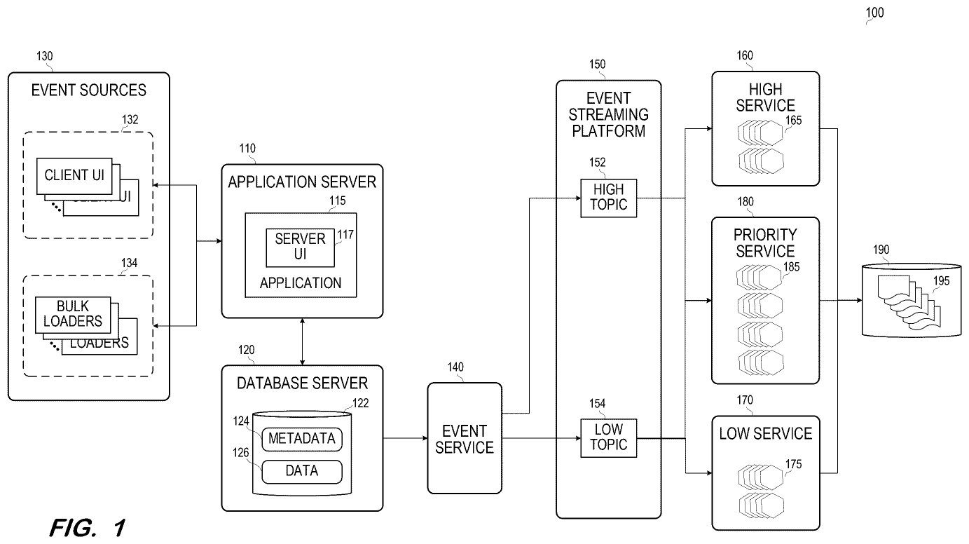

FIG. 1 illustrates system 100 according to some embodiments. The components of system 100 may be implemented using any suitable combinations of computing hardware and/or software that are or become known. Each component of system 100 may be located on-premise, cloud-based (e.g., in which computing resources are virtualized and allocated elastically), distributed (e.g., using distributed software, storage nodes and/or compute nodes) and/or deployed in any other suitable manner.

Each of components 110, 120, 140, 150, 160, 170, 180, and 190 may comprise an execution environment consisting of one or more servers, one or more virtual machines (which themselves are implemented by one or more servers), one or more clusters of nodes of a container orchestration system, and any other combination that is or becomes known. An execution environment may execute multiple instances of the same service, application or other process to provide increased throughput as is known in the art. All or a part of each component may utilize Infrastructure-as-a-Service (IaaS), Platform-as-a-Service (PaaS) and/or Software-as-a-Service (SaaS) offerings owned and managed by one or more different entities as is known in the art. A cloud-based implementation of any components of system 100 may apportion computing resources elastically according to demand, need, price, and/or any other metric.

Application server 110 may provide an operating system, services, I/O, storage, libraries, frameworks, etc. to applications executing therein. Application 115 may comprise program code executable by a processing unit of application server 110 to provide functions based on coded logic and data stored in database server 120. Application 115 may provide any computing functions that are or become known, including but not limited to enterprise resource planning, customer relationship management, supplier relationship management, human resource management, and field service management.

Application 115 may comprise a multi-tenant application, but embodiments are not limited thereto. Multi-tenancy is a software architecture pattern which facilitates the sharing of computing resources (e.g., processor cycles, memory) among disparate groups of users. For example, a single multi-tenant application may serve requests received from several independent tenants (e.g., customers) each consisting of multiple end users. Such an application may use a much smaller computing resource footprint than would be required to provision one application per tenant.

Database server 120 includes data storage system 122 which may consist of any type of standalone or distributed data storage systems that are or become known, including but not limited to fixed disks, Flash memory, read-only memory and non-volatile random-access memory. Database server 120 may be partially or fully remote application server 110, and may be distributed as is known in the art Data storage system 122 stores metadata 124 and data 126 as is known in the art. Metadata 124 may include database table names, table column names (e.g., Address, Sales) and a data schema defining data objects, mappings thereof to database tables, and logical relationships between database tables. Data 126 may comprise tabular data stored in a columnar or row-based format, object data or any other type of data that is or becomes known. Data 126 may include specific instances of types of data objects defined in metadata 124. In one example, data 126 may comprise a Sales Order database table in which each row includes data of a respective data object instance of a Sales Order-type data object.

Metadata 124 and data 126 may include metadata and data of multiple tenants as is known in the art. Application 115 may be configured to return only data of a tenant associated with a requesting user. Tenant-specific data may be identified within data 126 using tenant-specific identifiers. In a case that application 115 is a multi-tenant application, application 115 may leverage such tenant-specific identifiers within its queries of database server 120. Embodiments may be implemented in other types of multi-tenant architectures.

Event sources 130 communicate with application 115 via APIs exposed by application 115. For example, client UI applications 132 may be executed by respective user devices such as but not limited to a laptop computer, a desktop computer, a smartphone, and a tablet computer. A client UI application 132 may comprise a Web browser or another application (e.g., a front-end UI application which executes within a virtual machine of a Web browser) to provide user interfaces which use APIs to interact with server UI application 117.

Users (not shown) interact with client UI applications 132 to instruct application 115 to perform operations on data 126. Such operations may include operations to create, read, update, and delete data object instances. Creation of a data object instance may include instantiating an instance of a data object type. For example, creation of a Sales Order data object instance may include instantiating an instance of a Sales Order data object type defined by metadata 124, generating an identifier of the instance, adding a row including the identifier to a Sales Order table of data 126, and populating the row with data of the instance.

Event sources 130 also include bulk loaders 134. Examples of bulk loaders 134 include but are not limited to backed on-premise systems. Bulks loader 134 may aggregate many (e.g., thousands, millions) of modifications to data object instances into a batch and send the batch via REST APIs or scripts to application 115. Batches may be sent nightly, weekly, etc. As described above, updating a document database based on a large batch of modifications may cause a processing bottleneck.

According to some embodiments, database server 120 includes database triggers which fire events based on modifications to data 126. An event may consist of an identifier of a data object instance which was modified (i.e., created, updated or deleted) and the operation which was applied to the data object instance. The operation may include creation of all the fields of the data object instance, update of one or more fields of the data object instance, or deletion of the data object instance.

The fired events are received by event service 140. Event service 140 sends received events to either high topic 152 or low topic 154 of event streaming platform 150 (e.g., Kafka). Event service 140 may send events triggered by changes initiated from client UI applications 132 to high topic 152 and may send events triggered by changes initiated from bulk loaders 134 to low topic 154. Event service 140 may utilize any suitable system for determining a source of an event.

According to some embodiments, an API used by client UI applications 132 to modify (i.e., create, update or delete) a data object instance includes a field (e.g., lastChangedBy) which is not present in the scripts or REST APIs used by bulk loaders 134. Accordingly, event service 140 may review a received event to determine whether the event includes the field. If so, event service sends the event to high topic 152 and, if not, event service 140 sends the event to low topic 154.

High topic 152 and low topic 154 may comprise event logs maintained by event streaming platform 150. The events of each of high topic 152 and low topic 154 are ordered in time and written in a durable manner. Event service 140 may invoke an API provided by event streaming platform 150 to write events to high topic 152 and to low topic 154.

Service 160 receives events from high topic 152. Service 160 subscribes to high topic 152 and may receive events therefrom using a push-based or pull-based protocol. Similarly, service 170 subscribes to low topic 154 and receives events therefrom. On the other hand, service 180 subscribes to both high topic 152 and to low topic 154 and receives all events present on each topic.

Events stored by topics 152 and 154 may be associated with object instances associated with a set of data object types. Services 160 and 170 include handlers for handling events associated with data object instances of a particular subset of the data object types, while service 180 may include handlers for handling events associated with data object instances of the data object types which do not belong to the particular subset. Accordingly, service 180 may ignore events associated with data object instances of data object types which belong to the particular subset, and services 160 and 170 may ignore events associated with data object instances of the data object types which do not belong to the particular subset.

In one non-exhaustive example, the events stored by topics 152 and 154 are associated with object instances of twenty different data object types. Services 160 and 170 include handlers for handling events on data object instances of a same fifteen of the twenty object types, while service 180 includes handler for handling events on data object instances of the remaining five of the twenty object types. These five object types are referred to herein as priority object types, and the fifteen other object types are referred to as non-priority object types. Priority object types may be defined by a developer and may include object types whose instances are updated by event sources 130 more often than instances of non-priority object types and/or whose instance updates are to reflected in a document database more quickly than updates to instances of other object types.

Each of services 160, 170 and 180 is implemented using multiple instances of the same process, or service. The process instances of services 160, 170 and 180 process the received events in parallel. Generally, the more process instances executed by a service, the faster the service can process its received events.

According to some embodiments, each of services 160, 170 and 180 is implemented by a container orchestration platform such as but not limited to Kubernetes. Service 160 includes ten Kubernetes pods 165, each of which executes a first service which includes handlers for handling events on data object instances of the fifteen non-priority object types. Service 170 also includes ten pods 175, each of which executes a second service which includes handlers for handling events on data object instances of the fifteen non-priority object types. In this regard, the first service and the second service may be identical in some embodiments.

Service 180 includes twenty pods 185, each of which executes a second service which includes handlers for handling events on data object instances of the fifteen priority object types. By devoting more pods and therefore more computing resources to service 180 than to services 160, 170, service 180 provides more throughput for processing events and updating document database 190 than services 160, 170.

Embodiments of services 160, 170, 180 are not limited to any particular number of pods, or simultaneously executing service instances. Embodiments are also not limited to using an identical number of pods for services 160 and 170. The number of pods per each service need not be fixed and may be scaled elastically as is known in the art to achieve a desired response time, desired throughput per service, an average processing queue size per service, and/or or other performance metrics.

For example, a response time for a given service is proportional to the number of pods of the service and indirectly proportional to the number of object types handled by the service and to the rate of events received by the service. Advantageously, the number of pods of each service, the number of object types handled by each service, and the event sources handled by each service may be configured such that the total throughput of all the services is less than an overall limit imposed by the resources of the document database (i.e., so as not to overwhelm the document database). The event sources handled by a service may be considered a proxy for a rate of events to be handled by the service. For example, a service which handles only events received from a UI (i.e., events of high topic 152) is expected to receive events at a slower rate than a service which handles only events received from bulk loaders (i.e., events of low topic 154). Accordingly, even if service 160 and service 170 include the same number of pods, service 160 is expected to provide a faster response time than service 170 because service 160 is expected to receive events at a slower rate than service 170.

If a response time of a given service is too low, the response time may be increased by reducing the number of object types handled by the service, increasing the number of pods of the service, and/or changing a source of the events handled by the service to a source having a lower rate of events. Assuming a desire to maintain a current overall throughput so as not to overwhelm a document database which is being updated based on the events, the throughput of one or more other services may be correspondingly reduced (thereby increasing the response time of the one or more other services) by increasing the number of object types handled by the one or more other services, decreasing the number of pods of the one or more other services, and/or changing sources of the events handled by the one or more other services to sources having a higher rate of events.

On the other hand, if it is determined that the document database has reached an undesirable level of resource usage, this usage may be reduced by increasing the number of object types handled by and/or decreasing the number of pods of one or more services.

Document database 190 stores documents 195 as is known in the art. Document database 190 may be distributed and may provide resiliency through replication. Document database 190 provides fast searching and retrieval of documents 195 and of objects within documents 195. Document database 190 support fuzzy searching as is known in the art.

Each document 195 includes fields of one or more data object types. Document database 190 provides a flexible schema such that each of documents 195 may include different sets of fields. Documents 195 store data in field: value pairs. The values may comprise various types and structures, including strings, numbers, dates, arrays, or objects. Documents 195 may conform to a format such as but not limited to JSON, BSON, and XML.

Fields of a given data object type may be present in one or more of documents 195. Accordingly, in order for database 190 to consistently reflect changes made to an instance of a given data object type within data 126, those changes should be made to each document 195 which includes fields of the given data object type. As will be described in detail below, such changes are made by a service 160, 170, 180 which receives an event describing the changes and which includes handlers for the given data object type. Document database 190 exposes an API which services 160, 170 and 180 may use to perform operations (i.e., create, read, update and delete) on documents 195.

A document 195 may include fields of a several data object types. A document 195 may therefore be updated by more than one of services 160, 170 and 180 if the document includes fields of data object types whose handlers are provided by more than one of services 160, 170 and 180.

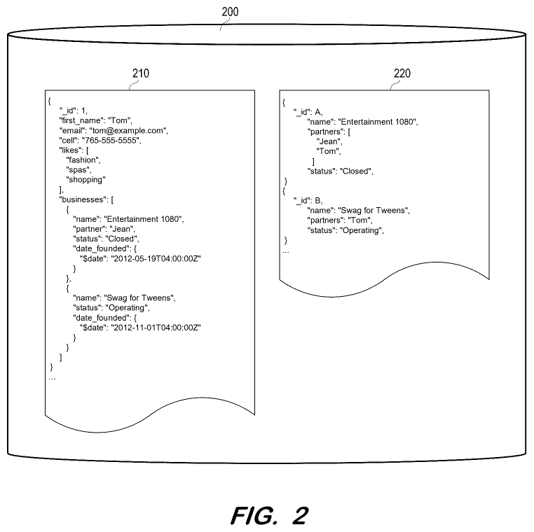

FIG. 2 illustrates portions of documents 210 and 220 within a document database 200 according to some embodiments. By way of example, document 210 includes object “1” and document 220 includes objects “A” and “B”. Each of documents 210 and 220 may include many more objects.

Documents 210 and 220 include field: value pairs in a hierarchical format. Since a search of database 200 returns document objects, the field: value pairs of a given document may be selected to provide a combination of data which may be desired for particular use case. For example, the field: value pairs of the objects of document 210 provide a general and business-related overview of a customer, while the field: value pairs of the objects of document 220 provide business status information.

As described above, updates to a data object instance of data 126 may require updates to multiple documents of database 200. For example, the value “Tom” of the field “first name” of an instance of a Customer data object type may be changed to “Thomas” in data 126. Accordingly, the corresponding value “Tom” of the field “first_name” of object “1” of document 210 should be changed to “Thomas”. Also, the corresponding value “Tom” of the field “partners” of objects “A” and “B” of document 220 should be changed to “Thomas”.

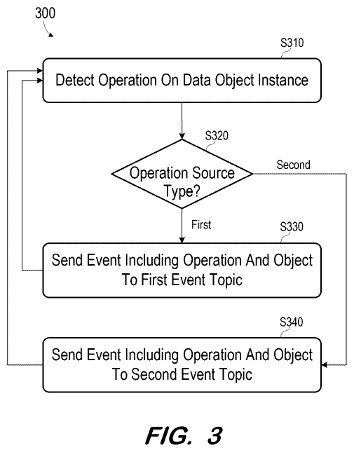

FIG. 3 comprises a flow diagram of process 300 to transmit incoming events to an event streaming platform according to some embodiments. Process 300 and the other processes described herein may be performed using any suitable combination of hardware and software. Program code embodying these processes may be stored by any non-transitory tangible medium, including a fixed disk, a volatile or non-volatile random-access memory, a DVD, a Flash drive, or a magnetic tape, and executed by any one or more processing units, including but not limited to a processor, a processor core, and a processor thread. Embodiments are not limited to the examples described below.

An operation on a data object is detected at S310. The operation may be detected by a service which receives events from database triggers which react to changes made to tables of a relational database. Accordingly, prior to S310, a data object instance of a relational database may be changed (i.e., created, updated, deleted) by a UI event or a bulk upload of changes.

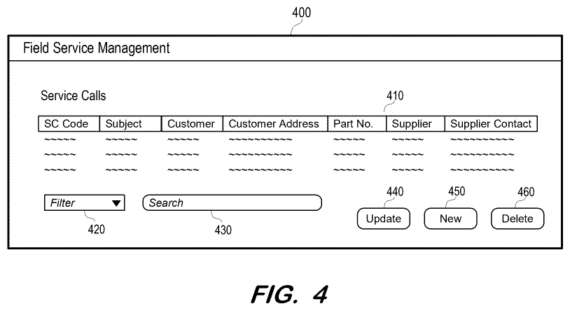

FIG. 4 illustrates user interface 400 of a client application according to some embodiments. In one example, a client UI application 132 executes a Web browser to access server UI 117 via HTTP and to render user interface 400 based on data received therefrom. User interface 400 includes table 410 showing field values for each of several instances of a Service Call data object. Drop-down menu 420 allows for filtering of the object instances of table 410, and search control 430 allows for searching of object instances. Search control 430 may also allow fuzzy searching of documents 195 of document database 190, some of which may include one or more fields of the Service Call data object.

An operator may select a displayed object instance and Update control 440 to update values of one or more fields of the selected data object instance. Additionally, the operator may select New control 450 to create a new data object instance and Delete control 460 to delete a selected object instance. In response to any such update, creation or deletion, application 115 instructs database server 120 to change corresponding data of data 126. The change causes a database trigger to provide a corresponding event to event service 140. The event is detected at S410 and may consist of an identifier of a data object instance which was modified (i.e., created, updated or deleted) and the operation which was applied to the data object instance. The operation may include creation of all the fields of the data object instance, update of one or more fields of the data object instance, or deletion of the data object instance.

A source of the operation is determined at S320. According to some embodiments, possible sources of the operation may be a client UI and a bulk upload. For example, an API used by client UI applications 132 to modify (i.e., create, update or delete) a data object instance may includes a field (e.g., lastChangedBy) which is not present in scripts or REST APIs used by bulk loaders 134 to bulk upload a set of operations. Accordingly, S320 may include reviewing the detected operation to determine whether the data object instance of the operation includes the field. If so (i.e., the event originated from a client UI application), flow proceeds to S330. If not (i.e., the event originated from a bulk upload), flow proceeds to S340.

At S330, an event including an operation and identifying a data object instance on which the operation was applied is sent to a first event topic of an event streaming platform. As mentioned above, an event topic may comprise a time-ordered event log in some embodiments. The first event topic may comprise high topic 152 and include events which originated from a client UI application. Similarly, at S340, an event including an operation and identifying a data object instance on which the operation was applied is sent to a second event topic of the event streaming platform. The second event topic may comprise low topic 154 and include events which originated from bulk uploads of data changes. The event streaming platform may expose APIs for writing events to specified topics, and such APIs may be used at S330 and S340.

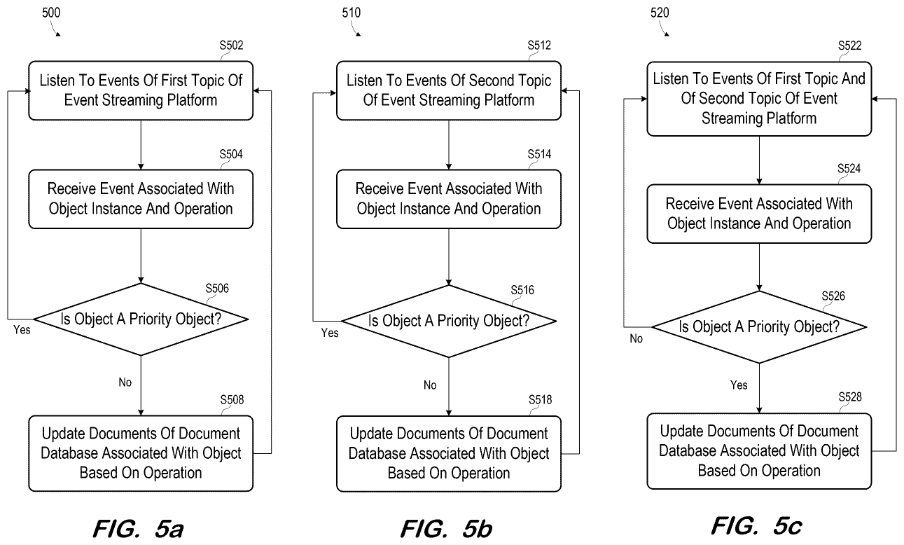

FIG. 5a, FIG. 5b and FIG. 5c comprise flow diagrams of processes to update a document database according to some embodiments. For purposes of example, it will be assumed that process 500 of FIG. 5a is performed by service 160, process 510 of FIG. 5b is performed by service 170, and process 520 of FIG. 5c is performed by service 180.

At S502, service 160 listens to events of first topic 152 of event streaming platform 150. Service 160 may subscribe to topic 152 using a subscription mechanism provided by platform 150 or otherwise be figured to receive events stored into topic 152. An event of the first topic is received at S504, using a push-based, pull-based or other protocol. The received event is associated with a data object instance of a data object type and an operation which modifies the data object instance.

Next, at S506, it is determined whether the data object type of the data object instance is a priority object type. In a case that service 160 is configured to include handlers only for non-priority object types, the determination at S506 may comprise a determination of whether service 160 includes handlers for the data object type of the data object instance. S506 may comprise comparing the data object type of the data object instance against a list of predefined priority data object types.

If the object type is a priority object type, flow returns to S502 to continue to listen for events on the first topic. Accordingly, service 160 does not update database 190 based on the event received at S504. Flow proceeds to S508 if it is determined at S506 that the object type is not a priority object type.

At S508, documents of document database 190 which are associated with the object instance are updated based on the operation of the received event. For example, every document 195 which includes updated fields of the object instance is identified and the fields are updated as specified in the operation of the event. If the operation is a create operation, every document 195 which includes fields of the object type is updated to include values of those fields of the newly-created object instance. Similarly, if the operation is a delete operation, every document 195 which includes fields of the object type is updated to delete values of those fields of the deleted object instance. Flow then returns to S502.

Process 510 of FIG. 5b is similar to process 500, albeit with respect to a second topic of the event streaming platform. service 170 listens to events of second topic 154 of event streaming platform 150 at S512 and receives an event of the second topic at S514. The received event is associated with a data object instance of a data object type and an operation which modifies the data object instance.

At S516, it is determined whether the data object type of the data object instance is a priority object type. If so, flow returns to S512 without updating database 190 based on the received event to continue to listen for events on the second topic. If it is determined at S516 that the object type is not a priority object type, documents of document database 190 which are associated with the object instance are updated at S518 based on the operation of the received event. For example, every document 195 which includes updated fields of the object instance is identified and the fields are updated as specified in the operation of the event. Flow then returns to S512 to continue to listen for events on the second topic.

As described above, service 180 may execute process 520 to listen to events of first topic 152 and of second topic 154 at S522. An event from one of the topics is received at S524. It is determined at S526 whether the data object type of the data object instance is a priority object type. Service 180 may be configured to include handlers only for priority object types, in which case the determination at S526 may comprise a determination of whether service 180 includes handlers for the data object type of the data object instance.

If the object type is a not priority object type, flow returns to S522 without updating database 190 to continue to listen for events on the first topic and the second topic. Flow proceeds to S528 if it is determined at S526 that the object type is a priority object type. Documents of document database 190 which are associated with the object instance of the received event are updated at S528 based on the operation specified by the received event.

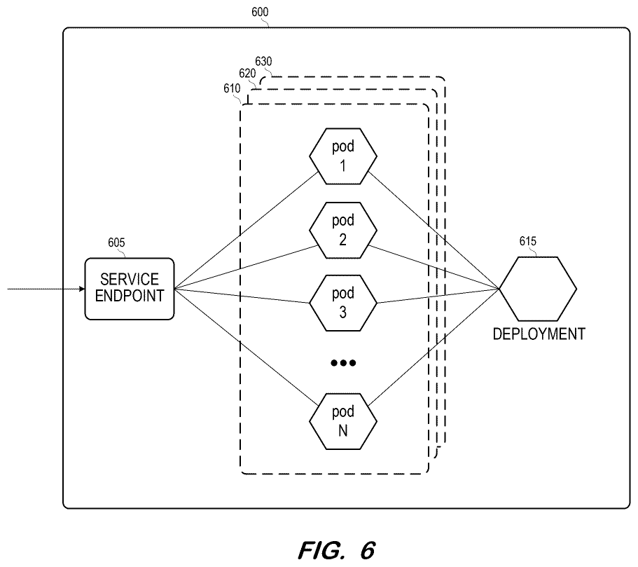

Services 160, 170 and 180 may be implemented using multiple instances of the same process, or service. FIG. 6 illustrates nodes 610, 620 and 630 deployed in cluster 600 of a service according to some embodiments. Each of nodes 610, 620 and 630 is physical machine or a virtual machine composed of resources of one or more physical machines. Node 610 executes N pods and nodes 620 and 630 may execute any number of pods. Each pod includes one or more containers, and each container may execute a service which independently provides the functionality provided by platform 600. For example, in a case that cluster 600 implements service 180, each container may execute a service which functions as described herein with respect to service 180. According to some embodiments, service endpoint 605 receives an event specifying an operation and a data object instance and routes the event to a pod of one of nodes 610, 620 and 630 for processing thereby. Deployment component 615 may adjust the number of nodes, pods, and containers of cluster 600 as desired.

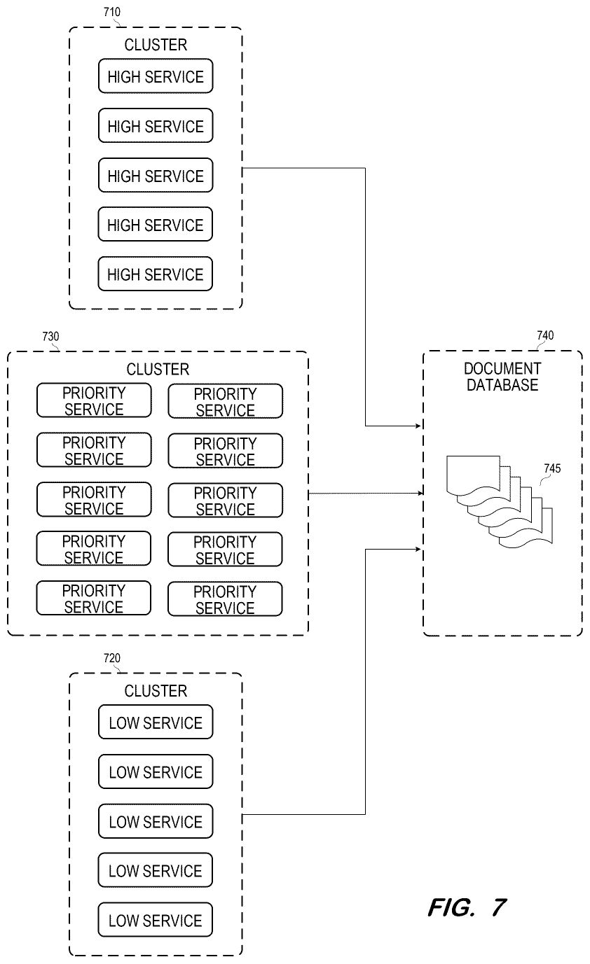

FIG. 7 illustrates clusters of services for updating a document database according to some embodiments. As shown, each of clusters 710, 720 and 730 provides the functionality of services 160, 170 and 180, respectively. More specifically, each pod of high cluster 710 may update documents 745 of database 740 based on UI-initiated events including operations on data object instances of non-priority data object types. Each pod of low cluster 720 may update documents 745 of database 740 based on bulk upload-initiated events including operations on data object instances of non-priority data object types. Finally, each pod of priority cluster 730 may update documents 745 of database 740 based on UI-or bulk upload-initiated events including operations on data object instances of priority data object types.

FIG. 7 depicts a number of pods within each cluster 710, 720 and 730, each of which are capable of executing the service of the cluster. FIG. 7 is intended to depict the allocation of a greater amount of computing resources to priority service 730, thus the pods of FIG. 7 may also be considered as nodes or containers.

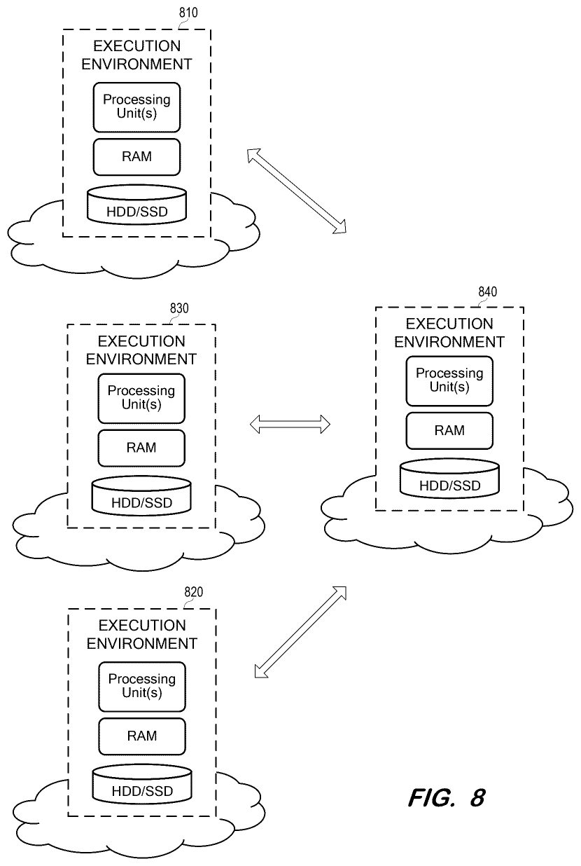

FIG. 8 illustrates a cloud-based database deployment according to some embodiments. Execution environments 810-840 may support containerized applications which provide one or more services to users. The illustrated hardware components of execution environments 810-840 need not reside in a same physical system, and one or more hardware components may be distributed among multiple physical systems. Execution environments 810-840 may comprise cloud-based compute resources residing in one or more public clouds providing self-service and immediate provisioning, autoscaling, security, compliance and identity management features.

Execution environments 810, 820, 830 may execute services 160, 170, 180, respectively. The service executed by each execution environment may update documents of a document database provided by execution environment 840 as described herein.

The foregoing diagrams represent logical architectures for describing processes according to some embodiments, and actual implementations may include more, or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation some embodiments may include a processing unit to execute program code such that the computing device operates as described herein.

Embodiments described herein are solely for the purpose of illustration. Those in the art will recognize other embodiments may be practiced with modifications and alterations to that described above.

1. A system comprising:
a document database;
a first service executable to:
receive first events from a first event log, each first event associated with a data object and an operation on an instance of the data object;
determine that a type of a first data object of one of the first events is not a priority data object type; and
in response to the determination that the type of the first data object of the one of the first events is not a priority data object type, update a first one or more documents of the document database based on a first operation of the one of the first events, the updating including updating fields of the first one or more documents as specified in the operation associated with the first event;
a second service executable to:
receive second events from a second event log, each second event associated with a data object and an operation on an instance of the data object;
determine that a type of a first data object of one of the second events is not a priority data object type; and
in response to the determination that the type of the first data object of the one of the second events is not a priority data object type, update a second one or more documents of the document database based on a second operation of the one of the second events, the updating including updating fields of the second one or more documents as specified in the operation associated with the second event; and
a third service executable to:
receive the first events from the first event log and the second events from the second event log;
determine that a type of a third data object of one of the first events is a priority data object type;
in response to the determination that a type of the third data object of the one of the first events is a priority data object type, update a third one or more documents of the document database based on a third operation of the one of the first events, the updating including updating fields of the third one or more documents as specified in the operation associated with the first event;
determine that a type of a fourth data object of one of the second events is a priority data object type; and
in response to the determination that the type of fourth data object of the one of the second events is a priority data object type, update a fourth one or more documents of the document database based on a fourth data operation of the one of the second events, the updating including updating fields of the fourth one or more documents as specified in the operation associated with the second event.

2. The system of claim 1, wherein an update frequency of a priority data object type is greater than an update frequency of a non-priority data object type.

3. The system of claim 1, further comprising:
fourth service executable to:
receive events from a relational database, each event comprising a data object and an operation on an instance of the data object; and
determine to send the received events to the first event log or to the second event log based on a field of the data objects of the received events.

4. The system of claim 3, wherein the determination to send the received events to the first event log or to the second event log based on a field of the data objects of the received events comprises:
determining that a data object instance of a first received event includes a first field;
in response to the determination that the data object instance of the first received event includes a first field, send the first received event to the first event log;
determination that a data object instance of a second received event does not include the first field; and
in response to the determination that the data object instance of the second received event does not include the first field, send the second received event to the second event log.

5. The system of claim 1, wherein the first service does not update documents of the document database based on first events comprising a first data object which is of a priority data object type, and
wherein the second service does not update documents of the document database based on second events comprising a second data object which is of a priority data object type.

6. The system of claim 5, wherein the third service does not update documents of the document database based on third events comprising a third data object which is not of a priority data object type.

7. The system of claim 6, wherein the third service comprises more computing resources executing the third service than computing resources executing the second service or computing resources executing the first service.

8. The system of claim 7, wherein a number of priority data object types is less than a number of non-priority data object types.

9. The system of claim 1, wherein the third service comprises more computing resources executing the third service than computing resources executing the second service or executing the first service.

10. The system of claim 9, wherein a number of priority data object types is less than a number of non-priority data object types.

11. A method comprising:
receiving first events at a first service from a first event log, each first event associated with a data object and an operation on an instance of the data object;
determining, at the first service, that a type of a first data object of one of the first events is not a priority data object type;
in response to determining that the type of the first data object of the one of the first events is not a priority data object type, updating, by the first service, a first one or more documents of a document database based on a first operation of the one of the first events, the updating including fields of the first one or more documents as specified in the operation associated with the first event;
receiving second events at a second service from a second event log, each second event associated with a data object and an operation on an instance of the data object;
determining, at the second service, that a type of a first data object of one of the second events is not a priority data object type;
in response to determining that the type of the first data object of the one of the second events is not a priority data object type, updating, by the second service, a second one or more documents of the document database based on a second operation of the one of the second events, the updating including updating fields of the second one or more documents as specified in the operation associated with the second event;
receiving the first events from the first event log and the second events from the second event log at a third service;
determining, at the third service, that a type of a third data object of one of the first events is a priority data object type;
in response to determining that a type of the third data object of the one of the first events is a priority data object type, updating, by the third service, a third one or more documents of the document database based on a third operation of the one of the first events, the updating including updating fields of the third one or more documents as specified in the operation associated with the first event;
determining at the third service that a type of a fourth data object of one of the second events is a priority data object type; and
in response to determining that the type of fourth data object of the one of the second events is a priority data object type, updating, by the third service, a fourth one or more documents of the document database based on a fourth data operation of the one of the second events, the updating including updating fields of the fourth one or more documents as specified in the operation associated with the second event.

12. The method of claim 11, wherein an update frequency of a priority data object type is greater than an update frequency of a non-priority data object type.

13. The method of claim 11, further comprising:
receiving events from a relational database at a fourth service, each event comprising a data object and an operation on an instance of the data object; and
determining, at the fourth service, to send the received events to the first event log or to the second event log based on a field of the data objects of the received events.

14. The method of claim 13, wherein the determining to send the received events to the first event log or to the second event log based on a field of the data objects of the received events comprises:
determining at the fourth service that a data object instance of a first received event includes a first field;
in response to determining that the data object instance of the first received event includes a first field, sending the first received event to the first event log from the fourth service;
determining at the fourth service that a data object instance of a second received event does not include the first field; and
in response to determining that the data object instance of the second received event does not include the first field, sending the second received event to the second event log from the fourth service.

15. The method of claim 11, wherein the first service does not update documents of the document database based on first events comprising a first data object which is of a priority data object type,
wherein the second service does not update documents of the document database based on second events comprising a second data object which is of a priority data object type, and
wherein the third service does not update documents of the document database based on third events comprising a third data object which is not of a priority data object type.

16. The method of claim 11, wherein more computing resources execute the third service than execute the second service or the first service.

17. The method of claim 16, wherein a number of priority data object types is less than a number of non-priority data object types.

18. One or more non-transitory computer-readable media storing program code that, when executed by a computing system, causes the computing system to perform operations comprising:
receiving first events from a first event log, each first event associated with a data object and an operation on an instance of the data object;
determining that a type of a first data object of one of the first events is not a priority data object type;
in response to determining that the type of the first data object of the one of the first events is not a priority data object type, updating a first one or more documents of a document database based on a first operation of the one of the first events, the updating including fields of the first one or more documents as specified in the operation associated with the first event;
receiving second events from a second event log, each second event associated with a data object and an operation on an instance of the data object;
determining that a type of a first data object of one of the second events is not a priority data object type;
in response to determining that the type of the first data object of the one of the second events is not a priority data object type, updating a second one or more documents of the document database based on a second operation of the one of the second events, the updating including updating fields of the second one or more documents as specified in the operation associated with the second event;
determining that a type of a third data object of one of the first events is a priority data object type;
in response to determining that a type of the third data object of the one of the first events is a priority data object type, updating a third one or more documents of the document database based on a third operation of the one of the first events, the updating including updating fields of the third one or more documents as specified in the operation associated with the first event;
determining that a type of a fourth data object of one of the second events is a priority data object type; and
in response to determining that the type of fourth data object of the one of the second events is a priority data object type, updating a fourth one or more documents of the document database based on a fourth data operation of the one of the second events, the updating including updating fields of the fourth one or more documents as specified in the operation associated with the second event.

19. The one or more non-transitory computer-readable media of claim 18, the operations further comprising:
receiving events from a relational database, each received event comprising a data object and an operation on an instance of the data object; and
determining to send the received events to the first event log or to the second event log based on a field of the data objects of the received events.

20. The one or more non-transitory computer-readable media of claim 19, wherein determining to send the received events to the first event log or to the second event log based on a field of the data objects of the received events comprises:
determining that a data object instance of a first received event includes a first field;
in response to determining that the data object instance of the first received event includes a first field, sending the first received event to the first event log;
determining that a data object instance of a second received event does not include the first field; and
in response to determining that the data object instance of the second received event does not include the first field, sending the second received event to the second event log.
